(19) United States
(12) Patent Application Publication
(10) Pub. No.: US 2009/0195928 A1
(43) Pub. Date: Aug. 6, 2009

(54) MAGNETIC DISK APPARATUS

(75) Inventor: Takehiro Ogawa, Higashine (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/267,322

(22) Filed: Nov. 7, 2008

(30) Foreign Application Priority Data
Feb. 4, 2008 (JP) 2008-024440

(51) Int. Cl. G11B 5/82

(52) U.S. Cl. 360/135

(57) ABSTRACT

A magnetic disk apparatus includes a non-volatile memory for saving read data and write data transmitted from a host. The magnetic disk apparatus includes a non-volatile memory that saves read data and write data transmitted from a host. The non-volatile memory has a host designated data area that saves host designated data designated by the host, and an independent data area that independently saves data other than the host designated data wherein the independent data area comprises a read data area that saves read data based on a read request command transmitted from the host and a write data area that saves write data based on a write request command.

### BACKGROUND OF THE INVENTION

1. Field of the Invention

Example embodiments discussed herein are directed to a magnetic disk apparatus including a non-volatile memory for saving read data and write data transmitted from a host, and particularly, to a hybrid magnetic disk apparatus that may effectively utilize a non-volatile memory mounted on the magnetic disk apparatus.

2. Description of the Related Art

In recent years, a magnetic disk apparatus (Hybrid Hard Disk Drive) mounted with a high-capacity (256 MB or 512 MB) non-volatile memory has been known (see, for example, Japanese Patent Laid-Open Nos. 2006-302315, 2001-350669, and 07-248973). The magnetic disk apparatus including such a high-capacity non-volatile memory may save frequently accessed data in the non-volatile memory in advance based on a command transmitted from a host. Therefore, a response time to the command may be reduced by omitting the access time to the disk medium.

Such a non-volatile memory mounted on the hybrid magnetic disk apparatus stores data of predetermined areas (for example, “LBA 0 to 500”) stored in a disk medium. However, if a read request of data (for example, LBA 600) that is not stored in the non-volatile memory is issued from the host, the data needs to be read from the disk medium, because the data does not exist in the non-volatile memory. Therefore, there is a issue that the access speed decreases.

There is also a issue that the high-capacity non-volatile memory mounted on the magnetic disk apparatus cannot be effectively utilized if the host system does not actually support access of a command to the non-volatile memory.

The magnetic disk apparatus according to the present embodiment has been made to solve the issues of the conventional technology. An object is to provide a magnetic disk apparatus capable of reducing the access speed and of effectively utilizing a non-volatile memory mounted on the magnetic disk apparatus even if the host system does not support access of a command to the non-volatile memory.

### SUMMARY

In accordance with an aspect of embodiments, a magnetic disk apparatus includes a non-volatile memory that saves read data and write data transmitted from a host. The non-volatile memory has a host designated data area that saves host designated data designated by the host, and an independent data area that independently saves data other than the host designated data wherein the independent data area comprises a read data area that saves read data based on a read request command transmitted from the host and a write data area that saves write data based on a write request command.

Other features and advantages of embodiments of the invention are apparent from the detailed specification and, thus, are intended to fall within the scope of the appended claims. Further, because numerous modifications and changes will be apparent to those skilled in the art based on the description herein, it is not desired to limit the embodiments of the invention to the exact construction and operation illustrated and described, and accordingly all suitable modifications and equivalents are included.

### BRIEF DESCRIPTION OF THE DRAWINGS

FIG. 1 is an explanatory view for explaining features and outline of a magnetic disk apparatus according to an embodiment.

FIG. 2 is a block diagram showing a configuration of the magnetic disk apparatus of FIG. 1.

FIG. 3 is a flow chart for explaining a read command control process.

FIG. 4 is a flow chart for explaining a write command control process.

FIG. 5 is an explanatory view for explaining a power OFF sequence control process.

FIG. 6 is a flow chart for explaining the power OFF sequence control process.

FIG. 7 depicts an example of command data from a host upon a power OFF sequence.

### DETAILED DESCRIPTION OF EXAMPLE EMBODIMENTS

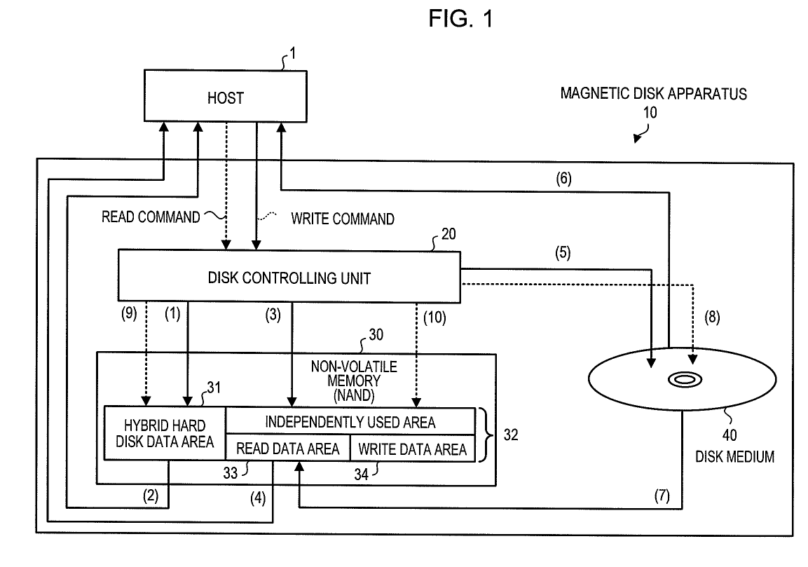

A first embodiment according to a magnetic disk apparatus of the present embodiment will now be described in detail with reference to the attached drawings. An outline and features of the magnetic disk apparatus according to the present embodiment will be described first, and then the magnetic disk apparatus according to the present embodiment will be described. FIG. 1 is an overall block diagram showing inside the magnetic disk apparatus. The present invention is not limited by the first embodiment illustrated below.

### Embodiment

(Outline and Features of the Magnetic Disk Apparatus)

An outline and features of the magnetic disk apparatus according to the present invention will be described first. FIG. 1 is an explanatory view for explaining the outline and features of the magnetic disk apparatus according to the present invention. As shown in FIG. 1, a magnetic disk apparatus 10 comprises a disk controlling unit 20 that analyzes a read command and a write command issued from a host 1, a disk medium 40 that stores data, and a non-volatile memory 30 that stores data of predetermined areas stored in the disk medium 40.

The non-volatile memory 30 mounted on the magnetic disk apparatus 10 has an area (hybrid hard disk data area 31) for storing (memorizing) data designated by the host 1 (data corresponding to commands that are not designated to be registered in PINN (PINN means pinning the storing data), a read area (read data area 33) which the magnetic disk apparatus 10 independently uses to save read data, and an area (write data area 34) for saving write data. This enables disk apparatus 10 to effectively utilize the high-capacity non-volatile memory 30 without depending on the host 1.

To specifically explain the main feature, as shown in FIG. 1, when a read command is issued from the host 1, the disk controlling unit 20 determines whether the read command is a command registered in PINN (see (1) of FIG. 1). If the read command is a command registered in PINN, the disk controlling unit 20 reads data from a hybrid hard disk data area 31 of the non-volatile memory 30 and forwards the data to the host 1 (see (2) of FIG. 1). If the read command is not a command registered in PINN and data corresponding to the read data area 33 of the non-volatile memory 30 exists (see (3) of FIG. 1), the disk controlling unit 20 reads the data from the read data area 33 and forwards the data to the host 1 (see (4) of FIG. 1).

If there is no data corresponding to the read data area 33, the controlling unit 20 reads data from the disk medium 40 (see (5) of FIG. 1) and forwards the read data to the host 1 (see (6) of FIG. 1). If there is a free space in the read data area 33 at this point, the data read from the disk medium 40 is saved in the read data area 33 as data with high frequency of use (see (7) of FIG. 1).

When a write command is issued from the host 1, the disk controlling unit 20 writes data of the write command in the disk medium 40 (see (8) of FIG. 1) and saves the data in the hybrid hard disk data area 31 if the write command is a command registered in PINN (see (9) of FIG. 1). If the write command is not a command registered in PINN and there is a free space in the write data area 34, the controlling unit 20 saves the data in the free space of the write data area 34 (see (10) of FIG. 1).

As described, in the present embodiment, the read data area 33 and the write data area 34 are areas for saving the data that is not designated to be registered in PINN. This enables use of the high-capacity non-volatile memory without depending on the host. Although deleting and writing must be performed block by block in the conventional non-volatile memory, the writing and erasing can be minimized by separating the data to be saved into the read/write areas, i.e., by fixing the areas (blocks) used for the read data (fix to read data area 33). As the write data is data to be rewritten into the disk medium 40, assembling and fixing the areas for the write data area 34, and erasing the write data all together after being rewritten into the disk medium 40, enables efficient erasing operation of the data saved in the non-volatile memory 30.

(Configuration of the Magnetic Disk Apparatus 10)

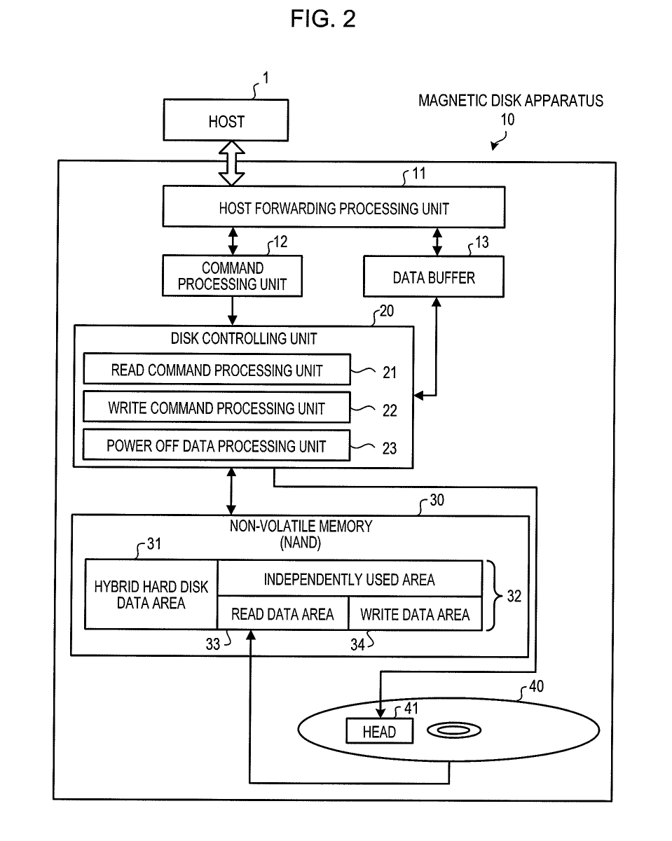

A configuration of the magnetic disk apparatus 10 according to the first embodiment will be described in detail. FIG. 2 is a block diagram showing the configuration of the magnetic disk apparatus 10 according to the first embodiment. An address that the host 1 (host system) shown in FIG. 1 designates is called PINN, which is set by the start LBA (LBA means Logical Block Address) and the number of sectors. The host system mounted with such a hybrid magnetic disk apparatus issues three types of commands (Add LBAs to NV Cache Pinnes Set command: command for designating address that uses non-volatile memory, Remove LBAs from NV Cache Pinned Set command: command for removing designation of address that uses non-volatile memory, and Flush NV Cache command: command for writing data of non-volatile memory in medium, using the high-capacity non-volatile memory.

As shown in FIG. 1, the magnetic disk apparatus 10 has a host forwarding processing unit 11, a command processing unit 12, a data buffer 13, a disk controlling unit 20, a disk medium 40, a head 41, and the non-volatile memory 30 (NAND).

The host forwarding processing unit 11 is a processing unit that transmits and receives commands and data to and from the host 1 connected with the magnetic disk apparatus 10, and specifically, receives the read command and the write command transmitted from the host 1 and transfers data to and from the disk controlling unit 20 through the data buffer 13.

The command processing unit 12 receives the read command, the write command, and other commands transmitted from the host 1, analyzes the received commands, and instructs a predetermined process to the disk controlling unit 20. The data buffer 13 temporarily stores data to be transmitted and received to and from the host 1.

The disk controlling unit 20 includes a memory (firmware circuit) that deploys firmware for executing a read command (read request) or a write command (write request) instructed by the command processing unit 12 to the disk medium 40 and executes various processes based on these. Particularly, the disk controlling unit 20 closely related to the present invention includes a read command processing unit 21, a write command processing unit 22, and a power OFF data processing unit 23.

The non-volatile memory 30 includes areas divided into two data areas: the hybrid hard disk data area 31 and an independent area 32. The independent area 32 is constituted by the read data area 33 and the write data area 34. Actually, in addition to the hybrid hard disk data area 31 and the independent area 32 that are data areas, the non-volatile memory 30 typically has a system area (not shown) that is a management data area for managing the data saved in the hybrid hard disk data area 31 and the independent area 32. For example, when a read request from a read command is issued, a PINN registration data area saved in the system area and an LBA address stored in the read area and the write area are first identified. The PINN registration data area is located, and the corresponding LBA address is searched. If the corresponding LBA address exists, data corresponding to the LBA address is read from the hybrid hard disk data area 31 of the data area.

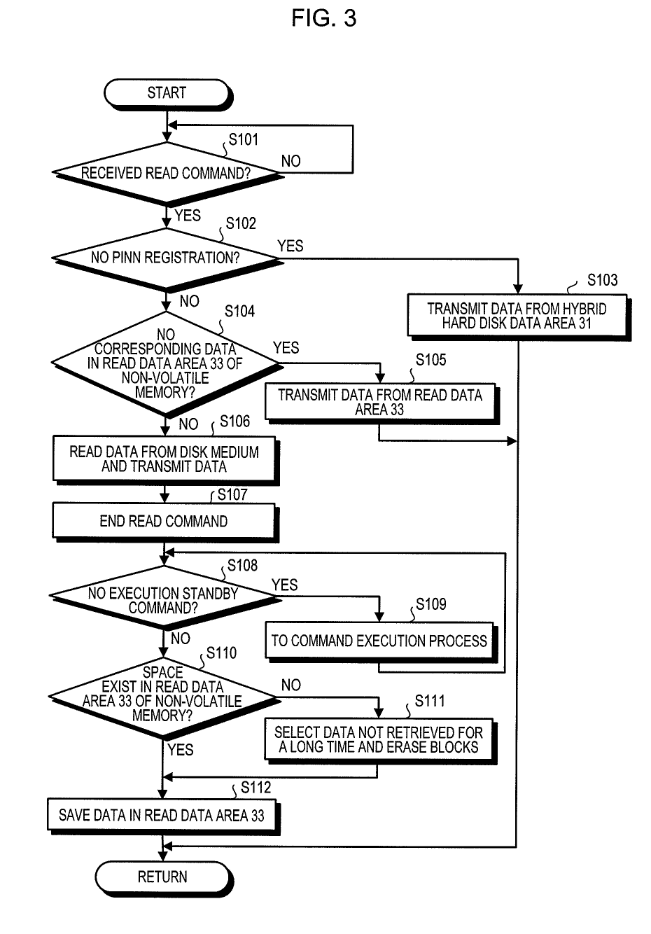

When receiving the read command from the host 1, the read command processing unit 21 executes a process of reading out the data from the disk medium 40 or from the hybrid hard disk data area 31 or the read data area 33 of the non-volatile memory 30. The specific control process by the read command processing unit 21 will be described in detail in the flow chart of FIG. 3.

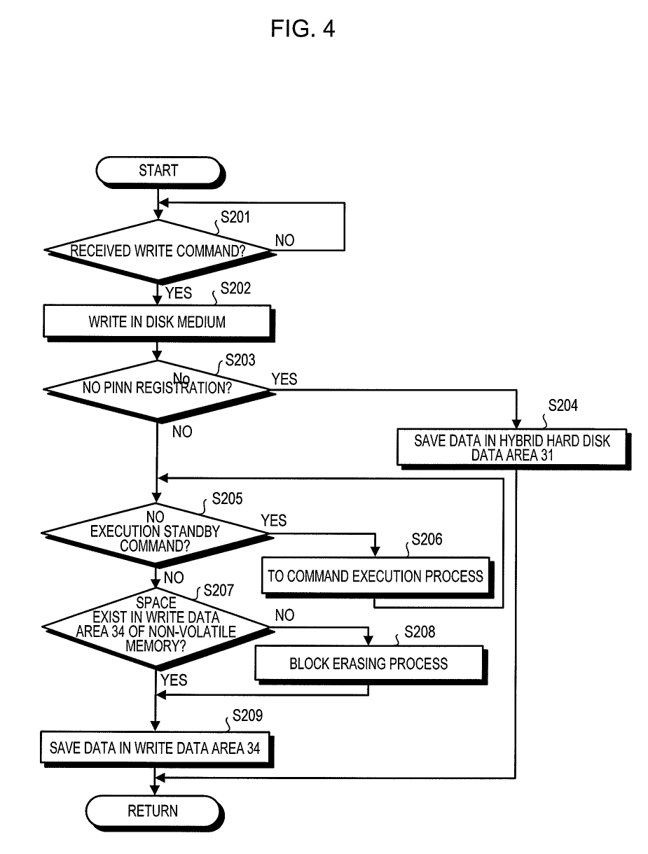

When receiving the write command from the host 1, the write command processing unit 22 executes a process of writing the data into the disk medium 40 or the write data area 34 of the non-volatile memory 30. The specific control process by the write command processing unit 22 will be described in detail in the flow chart of FIG. 4.

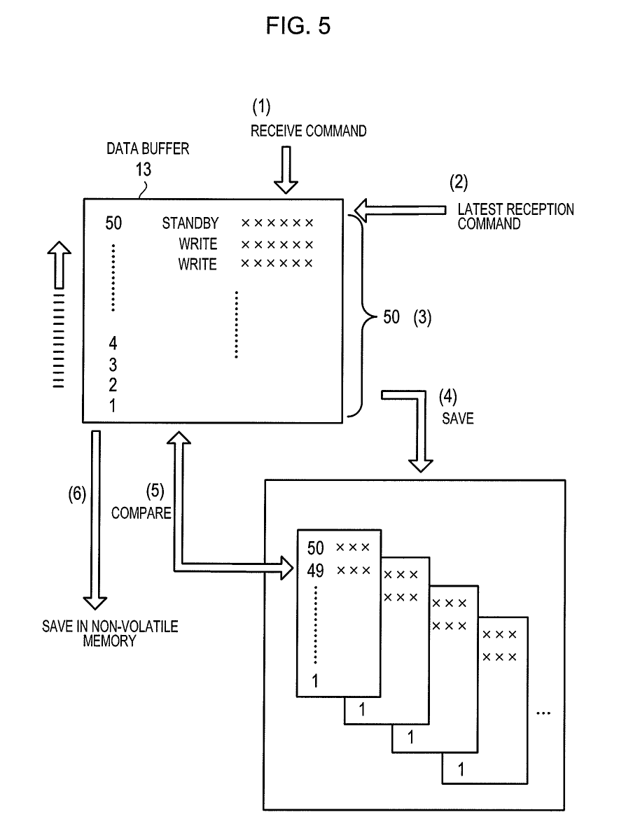

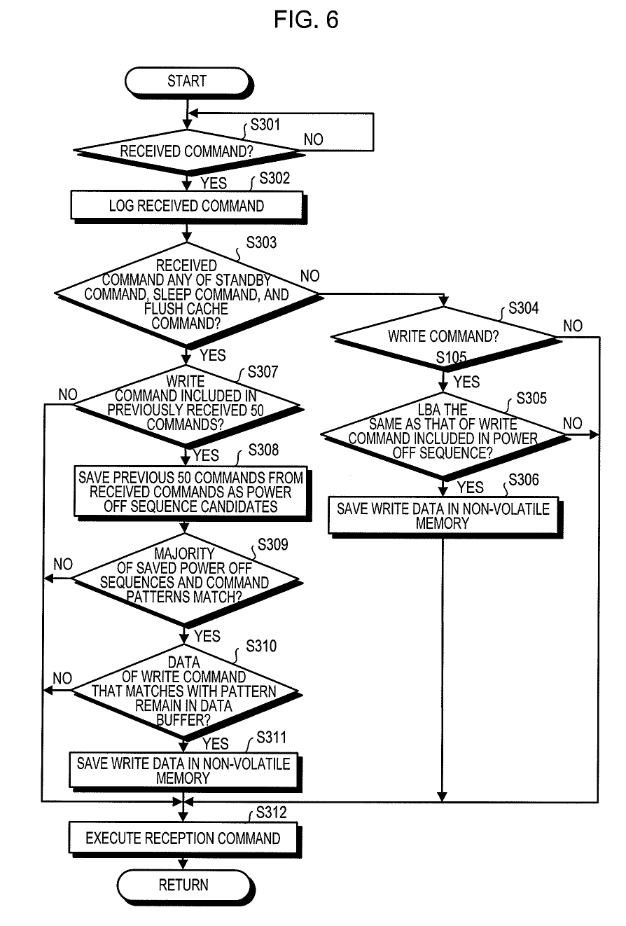

When receiving the command from the host 1, the power OFF data processing unit 23 saves a write command in the write data area 34 when receiving the write command corresponding to the power OFF sequence. The specific control process by the power OFF data processing unit 23 will be described in detail in the flow charts of FIGS. 5 and 6.

The disk medium 40 is a magnetic disk that stores applications and desired data, and the head 41 reads from and writes into the disk medium 40.

(Read Command Control Process)

A procedure of the “read command control process” according to the present embodiment will be described with reference to FIG. 3. FIG. 3 is a flow chart showing the procedure of the read command control process.

Specifically, after receiving a read command transmitted from the host 1 (step S101, Yes), whether the received read command is registered in PINN (is there data in the hybrid hard disk data area 31) is determined (step S102). Specifically, whether an LBA corresponding to the read command is registered in PINN is determined. If it is determined that the received read command is registered in PINN (step S102, Yes), the data saved in the hybrid hard disk data area 31 of the non-volatile memory 30 is forwarded to the host 1 (step S103), and the process returns to step S101.

If it is determined that the received read command is not registered in PINN (step S102, No), whether data corresponding to the read data area 33 of the non-volatile memory 30 exists is determined (step S104). If it is determined that the data corresponding to the read data area 33 of the non-volatile memory 30 exists (step S104, Yes), the data saved in the read data area 33 is forwarded to the host 1 (step S105), and the process returns to step S101.

On the other hand, if it is determined by the determination of step S104 that the data corresponding to the read data area 33 of the non-volatile memory 30 does not exist (step S104, No), the data is read out from the disk medium 40, the read data is forwarded to the host 1 (step S106), and the read command is terminated (step S107).

Subsequently, in step S108, whether an execution standby command exists is determined (step S108), and if the execution standby command exists (step S108, Yes), a standby command is executed (step S109). The process of steps S108 and S109 is repeated until there are no more execution standby commands.

If there are no more execution standby commands (step S108, No), whether there is a free space in the read data area 33 of the non-volatile memory 30 is determined (step S110). If it is determined that there is no free space in the read data area 33 (step S110, No), data that is not retrieved for a long time (data saved for a long time and not used) is selected based on the time stamp, and the selected read data is erased (erasing process) block by block (step S111). This produces a free space for new data to be saved, and frequently accessed data can be saved in the free space.

Meanwhile, if it is determined that there is a free space in the read data area 33 of the non-volatile memory 30 (step S110, Yes), the data read from the disk medium 40 in step S106 is saved in the free space of the read data area 33 (step S112), and the process returns to step S101. A faster access can be achieved by reading the data from the read data area 33 of the non-volatile memory 30 than by reading the data from the disk medium 40. Therefore, the data read from the disk medium 40 is saved as frequently accessed data in the read data area 33.

(Write Command Control Process)

The procedure of the “write command control process” according to the present embodiment will be described with reference to FIG. 4. FIG. 4 is a flow chart showing the procedure of the write command control process.

Specifically, when the write command transmitted from the host 1 is received (step S201, Yes), data of the received write command is written into the disk medium 40 (step S202). Whether an LBA corresponding to the write command is registered in PINN is then determined (step S201). If it is determined that the received write command is registered in PINN (step S203, Yes), the data of the write command is saved in the hybrid hard disk data area 31 (step S204), and the process returns to step S201.

On the other hand, if it is determined that the received write command is not registered in PINN (step S203, No), whether there is an execution standby command is determined (step S205), and if there is an execution standby command (step S205, Yes), the command is executed (step S206). The process of steps S205 and S206 is repeated until there are no more execution standby commands.

If there are no more execution standby commands (step S205, No), whether there is a free space in the write data area 34 of the non-volatile memory 30 is determined (step S207). If it is determined that there is a free space in the write data area 34 (step S207, Yes), the data is saved in the write data area 34 (step S209), and the process returns to step S201. On the other hand, if it is determined that there is no free space in the write data area 34 (step S207, No), a block erasing process is executed (step S208), the process shifts to step S209, the data is saved in the write data area 34 (step S209), and the process returns to step S201. In this way, blocks of a certain amount of data can be erased all together when there is no command to be executed. The frequently read data is saved in the write data area 34, thereby achieving a faster access.

(Power OFF Sequence Control Process)

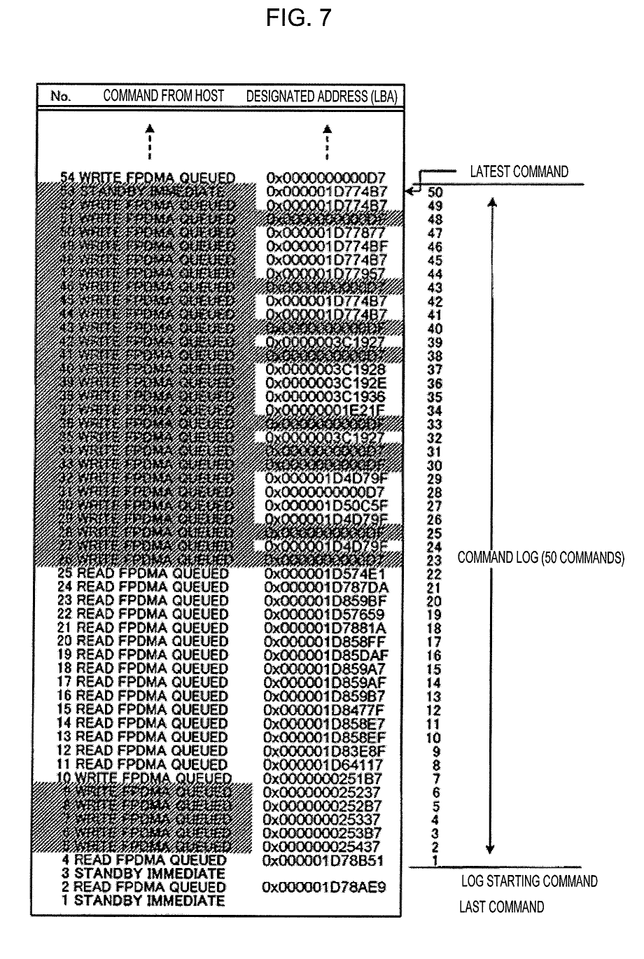

The procedure of the “power OFF sequence control process” according to the present embodiment will be described with reference to FIGS. 5 and 6. FIG. 5 is an explanatory view for explaining an outline of the power OFF sequence control process, while FIG. 6 is a flow chart showing the procedure of the power OFF sequence control process. FIG. 7 depicts an example of command data from the host upon the power OFF sequence.

More specifically, the host 1 conventionally executes a process of writing (saving) the write data remaining in the host 1 into the disk medium 40 of the magnetic disk apparatus 10 when turning OFF the power (when starting up the power OFF sequence). Therefore, the host 1 reads the data saved in the disk medium 40 upon power ON (upon startup) of the magnetic disk apparatus 10 (data saved before power OFF is often read upon the next power ON). This leads to a issue because the access time becomes long. Consequently, the power OFF sequence control process speeds up the startup by saving the data that is often read upon the next power ON (effective data) in the non-volatile memory 30.

The start determination of the power OFF sequence differs depending on the type of OS and the user environment. Therefore, the start determination is performed by analyzing the power OFF sequence with a procedure shown in FIG. 5 and the following (1) to (6) and then executing a control process of saving effective data in the write data area 34 of the non-volatile memory 30. (1) Periodically collect command logs transmitted from the host 1. (2) Log and save the command if the command transmitted before the power is turned off (latest reception command) is any of a Standby command, a Sleep command, and a Flush Cache command. (3) Determine the logs of the write data. (4) Save/compile a plurality of patterns of the write data. (5) Perform pattern matching by comparison, tracing back from the last log upon power ON, and recognize the same pattern as a power OFF sequence when the same pattern is detected. (6) Save the write data in the non-volatile memory 30 if a write command corresponding to a power OFF sequence is issued.

The procedure of the power OFF sequence control process will be described in detail with reference to the flow charts of FIGS. 5 and 6. As shown in the flow chart of FIG. 6, when a command transmitted from the host 1 is received (step S301, Yes), the received command is logged (step S302). The command transmitted from the host 1 is temporarily saved in the data buffer 13 (see (1) of FIG. 5).

Whether the received command is a command related to the power OFF sequence (Standby command, Sleep command, and Flush Cache command) is then determined (step S303). More specifically, whether the latest reception commands (50 commands) of the commands logged in the data buffer 13 are any of the Standby command, the Sleep command, and the Flush Cache command is determined (see (2) of FIG. 5). If the received command is not any of the Standby command, the Sleep command, and the Flush Cache command (step S303, No), whether the received command is a write command is determined (step S304).

If the received command is a write command (step S304, Yes), whether the LBA is the same as that of the write command included in the power OFF sequence is determined (step S305). If the LBA is the same as that of the write command included in the power OFF sequence (step S305, Yes), the write data is saved in the write data area 34 of the non-volatile memory 30 (step S306), the reception command is executed (step S312), and the process returns to step S301.

If the received command is not a write command according to the determination in step S304 (step S304, No), or when the LBA is not the same as that of the write command included in the power OFF sequence according to the determination in step S305 (step S305, No), the reception command is executed (step S312), and the process returns to step S301.

On the other hand, if the received command is any of the Standby command, the Sleep command, and the Flush Cache command according to the determination in step S303 (step S304, Yes), whether a write command is included within a previously received predetermined range (for example, 50 commands) is determined (see (3) of FIG. 5, step S307). An example of FIG. 7 illustrates that a 50th command of the latest reception commands is a Standby command.

If a write command is included within the received 50 commands (step S307, Yes), 50 commands before the received command are saved as power OFF sequence candidates in a system area (see (4) of FIG. 5, step S308). In this way, a plurality of sets of 50 commands (predetermined patterns) are saved as power OFF sequence candidates in the system area.

Whether a majority of the saved power OFF sequences and the command patterns match is determined (step S309). More specifically, whether 25 or more of the commands saved in advance as candidates of the power OFF sequence and current command patterns (types) match is determined (see (5) of FIG. 5).

If it is determined that a majority of the saved power OFF sequences and the command patterns match (step S309, Yes), whether data of a write command that matches with a command pattern remains in the data buffer 13 is determined (step S310). If it is determined that the data of a write command that matches with a pattern remains in the data buffer 13 (step S310, Yes), the write data is saved in the write data area 34 of the non-volatile memory 30 (see (6) of FIG. 5, step S311), the reception command is executed (step S312), and the process returns to step S301. If it is determined that a majority of the saved power OFF sequences and the command patterns do not match (step S309, No), or when it is determined that data of a write command that matches with a pattern does not remain in the data buffer 13 (step S310, No), the reception command is executed (step S312), and the process returns to step S301.

In the example of FIG. 7, a plurality of write data (WRITE FPDMA QUEUED xxxxx) are included in the command-logged 50 commands. The example illustrates that a majority of the write data patterns and the write data patterns of a plurality of commands saved in advance in the system area are matched (shaded part). According to the power OFF sequence control process shown in FIG. 6 described above, data that is frequently read upon the next power ON (effective data) can be saved in the write data area 34 of the non-volatile memory 30. This enables speed up of the startup upon power ON without being affected by the type of OS of the host 1 or the user environment. A similar advantage can be obtained by the power OFF sequence control process even if the system is in a standby state.

As described, the magnetic disk apparatus 10 of the present embodiment is constituted by dividing the non-volatile memory 30 into two areas: the hybrid hard disk data area 31 that stores data designated to be saved by the host 1; and the read data area 33 and the write data area 34 in which the magnetic disk apparatus 10 independently decides to save data. Thus, the non-volatile memory 30 mounted on the magnetic disk apparatus 10 can be effectively utilized even if the host 1 (host system) does not support access of a command to the non-volatile memory 30.

Among the processes described in the present embodiment, all or part of the processes described to be automatically performed may be manually performed. All or part of the processes described to be manually performed may be automatically performed with known methods. The processing procedures, control procedures, specific names, and information including various data and parameters illustrated in the document and the drawings may be arbitrarily modified unless otherwise specified.

The illustrated constituent elements of the devices are functional and conceptual and do not have to be physically constituted as illustrated. Thus, the specific configurations of distribution and integration of the devices are not limited to the ones illustrated, and all or part of the devices can be constituted by functionally or physically distributing and integrating in arbitrary units depending on various loads and status of use.

What is claimed is:

1. A magnetic disk apparatus comprising a non-volatile memory that saves read data and write data transmitted from a host,
the non-volatile memory comprising:
a host designated data area that saves host designated data designated by the host; and
an independent data area that independently saves data other than the host designated data;
wherein the independent data area comprises a read data area that saves read data based on a read request command transmitted from the host and a write data area that saves write data based on a write request command.

2. A magnetic disk apparatus comprising: a non-volatile memory that saves read data and write data transmitted from a host; and a firmware circuit,
the non-volatile memory comprising:
a host designated data area that saves host designated data designated by the host; and
an independent data area that independently saves data other than the host designated data, wherein
the firmware circuit predicts that the host will turn off the power and executes a process of saving read data before power-off in the non-volatile memory.

3. The magnetic disk apparatus according to claim 2, wherein
the independent data area comprises a read data area that saves read data based on a read request command transmitted from the host and a write data area that saves write data based on a write request command.

4. The magnetic disk apparatus according to claim 2, wherein
the firmware circuit periodically collects commands issued by the host, saves the collected commands in the read data area, compiles and compares the commands by a pattern matching process using a plurality of command logs to thereby recognize a power off sequence before power-off.

5. The magnetic disk apparatus according to claim 4, wherein
the pattern matching process uses, upon power-on, a plurality of command logs tracing back from the last command log collected upon power-off.

6. The magnetic disk apparatus according to claim 4, wherein
the pattern matching process determines, upon power-on, the correspondence of command type based on the plurality of command logs tracing back from the last command log collected upon power-off.

7. The magnetic disk apparatus according to claim 4, wherein
the type of the command log periodically collected from the host is one of a Standby command, a Sleep command, and a Flush Cache command that are commands related to the power off sequence.
